(19) United States
(12) Patent Application Publication
(10) Pub. No.: US 2015/0205369 A1
(43) Pub. Date: Jul. 23, 2015

(54) Rotary-Type Keyboard for Inputting Multiple Languages

(71) Applicant: Jin Won CHOI, (US)

(72) Inventor: Jin Won Choi, Changwon-si (KR)

(21) Appl. No.: 14/386,899

(22) PCT Filed: Dec. 21, 2012
(86) PCT No.: PCT/KR2012/011233

§ 371 Date: Mar. 17, 2015

(30) Foreign Application Priority Data
Mar. 22, 2012 (KR) 10-2012-0029229

(51) Int. Cl. G06F 3/02; G06F 3/023

(52) U.S. Cl. CPC G06F 3/0219; G06F 3/0233

(57) ABSTRACT

The present invention relates to a keyboard for inputting multiple languages using a detachable keypad, and more particularly, to a rotary-type keyboard for inputting multiple languages that includes a baseboard, rows of a plurality of key caps placed on the baseboard, and a plurality of moving mechanism members connecting the key caps to the baseboard and enabling the key caps to move upward and downward with respect to the baseboard. The key caps are divided into an opaque portion and a transparent portion, and have a plurality of rotatable members which are provided between the baseboard and the transparent portion in the direction in which the rows of key caps extend, and which have characters printed on the outer surfaces thereof. The plurality of rotatable members provide the user with different characters through the transparent portion depending on the angle of rotation.

### TECHNICAL FIELD

The present invention relates to a keyboard for inputting multiple languages using a detachable keypad and, more particularly, to an rotary-type keyboard for inputting multiple languages, including: a base board; rows of a plurality of key caps that are disposed on the base board; and a plurality of moving mechanism members that connect the key caps to the base board and enable the key caps to vertically move with respect to the base board, wherein the key caps each are divided into an opaque portion and a transparent portion and include a plurality of rotatable members provided between the base board and the transparent portion in a row direction of the key caps and having characters marked on outer surfaces thereof, wherein the plurality of rotatable members provide different characters through the transparent portion according to rotational angles for users.

### BACKGROUND

Keyboards, input devices of computers, may be classified as a mechanical, membrane, qwerty-type keyboard, and a touch screen and used to perform inputting in computers or mobile devices. Various languages exist throughout the world, and multiple applications, menus of system software, graphic user interfaces (GUIs), and speed keys, and the like, are used to input special characters in personal computers (PCs) or mobile devices.

Also, various speed keys are provided for various computer games.

However, conventional keyboards have a limitation in that they can only display one or two languages, requiring the role of helping input by marking various characters and symbols changing on a single keyboard.

As a solution, Korean Patent Registration No. 20-0289746 entitled a “Multi-language Window Automatic Control Device using Touch Keyboard” will be referred to as a related art keyboard using a touch screen.

This patent has shortcomings in that coordinate values should be designated for languages of each country in designing a screen, country language recognition information and display information corresponding to the coordinate values should be designed, a new touch keyboard including a back screen, which is not general nor familiar, should be created, and an extra space is required to store multi-language window data. In addition, since characters are selected upon receiving a language conversion key input through a touch keyboard, an extra storage device for character conversion is required so that when a character is selected, a screen may be converted into a window screen of a corresponding language. This may be utilized in a place such as an airport where foreigners come and go, but a display time may vary according to performance of storage devices and a global use is limited.

In addition, the foregoing patent is not applicable to a heterogeneous device, or the like, and since multi-language character strings are selectively displayed, a corresponding language is searched though several stages and displayed. Also, a character display unit is provided in a lower back screen and a contact part in which a touch is sensed based on a change in capacitance Cs is provided above the back screen, causing a high error rate of touch sensing, and a central processing unit for controlling a back screen that receives a multi-language driving control signal and converts it into a corresponding language and a monitor receiving a control signal and displaying a corresponding language should be required.

The present invention proposes a method for simply selecting characters, rather than a scheme of displaying character selection using such a complicated structure.

### SUMMARY

An aspect of the present disclosure provides a keyboard supporting multiple languages allowing users to replace and use a keypad as desired by using printed characters on one side and transparent keys and a rotary keypad on the other side.

In particular, a rotatable keypad includes a plurality of character tables at each angle to simply provide a keyboard corresponding to various characters.

Also, the transparent portion may serve as a magnifier to optically magnify a semi-transparent key, whereby a rotatable keypad can be minimized to contribute to reduce a size of a space in which the rotatable keypad is inserted, providing a configuration considering structures of a circuit or a grounding unit of the keyboard.

According to an aspect of the present invention, there is provided a keyboard including a base board; rows of a plurality of key caps positioned on the base board; and a plurality of moving mechanism members connecting the key caps to the base board and enabling the key caps to vertically move with respect to the base board.

In the keyboard, the key caps each are divided into an opaque portion and a transparent portion and include a plurality of rotatable members provided between the base board and the transparent portion in a row direction of the key caps and having characters marked on outer surfaces thereof, wherein the plurality of rotatable members provide different characters through the transparent portions according to rotational angles for a user.

In this case, the rotatable members are provided to have a circular shape, and a lower portion of the transparent portion has a concave recess corresponding to the rotatable members.

In particular, neighboring rotatable members, among the plurality of rotatable members, are connected through a connection member and interwork to be rotated by the same rotation angle.

In this case, a rotary motor for adjusting a rotational angle is connected to any one of the plurality of rotatable members.

According to the present invention, the keyboard supporting multiple languages allowing users to replace and use a keypad as desired by using printed characters on one side and transparent keys and a rotary keypad on the other side.

### BRIEF DESCRIPTION OF THE DRAWINGS

FIG. 1 is a perspective view of a general key board.

FIG. 2 is an exploded perspective view illustrating a configuration and an operating mechanism of the general keyboard.

FIGS. 3 through 8 are views illustrating a configuration of a keyboard according to the present invention.

FIGS. 9 and 10 illustrate another embodiment of a keyboard according to the present invention.

### DETAILED DESCRIPTION

Hereinafter, embodiments will be described in detail with reference to the accompanying drawings.

In describing the present invention, if a detailed explanation for a related known function or construction is considered to unnecessarily divert the gist of the present invention, such explanation will be omitted but would be understood by those skilled in the art. Also, similar reference numerals are used for the similar parts throughout the specification. Also, it should be noted that like reference numerals already used to denote like elements in other figures are used for elements wherever possible.

Moreover, the terms used henceforth have been defined in consideration of the functions of the present invention, and may be altered according to the intent of a user or operator, or conventional practice. Therefore, the terms should be defined on the basis of the entire content of this specification.

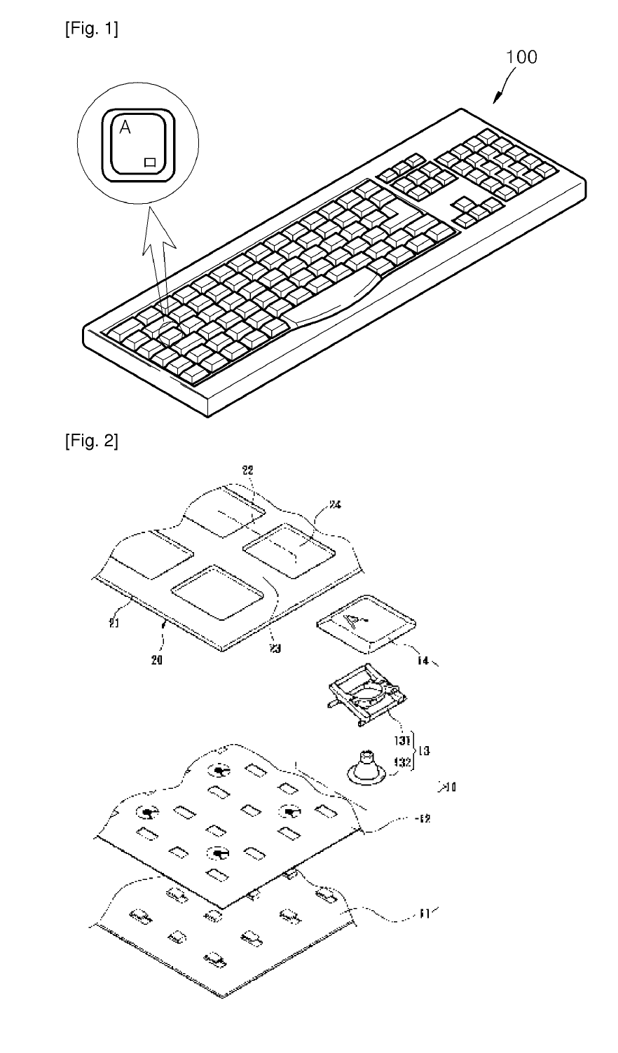

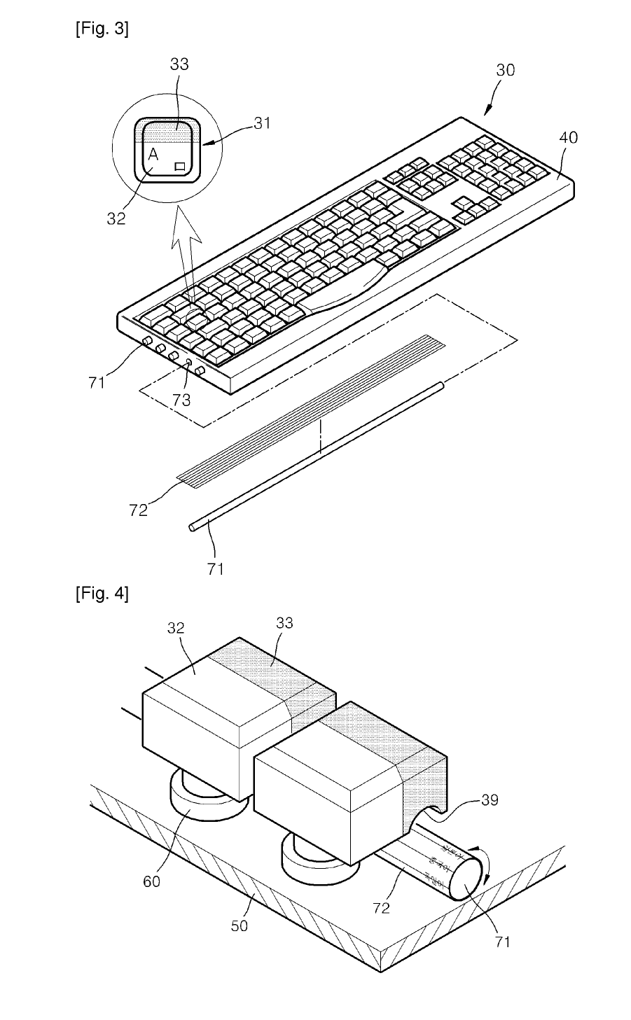

FIG. 1 is a perspective view of a general keyboard, and FIG. 2 is a view illustrating a mechanism of a general keyboard.

A keyboard unit 10 includes a base board 11 and rows of a plurality of key caps 14 positioned on the base board 11. The key caps 14 in neighboring rows are spaced apart by a first gap 15, and neighboring key caps 14 in each row are spaced apart by a second gap 16. The key caps 14 and the base board 11 are connected by a plurality of moving mechanisms 13. Each of the moving mechanisms 13 includes a movable member 131 connecting the key cap 14 to the base board 11 and an elastic member 132 supporting the key cap 14 to provide restoring force to the key cap 14. The key cap 14 may be pressed and may vertically move with respect to the base board 11 through the moving mechanism 13. Also, the keyboard unit 10 further includes a circuit board 12 interposed between the key caps 14 and the base board 11 to generate command signals based on a compression and touch of the elastic member 132 while the key caps 14 are moving vertically.

Such an operating mechanism may be used in the present invention and a “moving mechanism member 60” as described hereinafter may be considered to be identical to the moving mechanism of FIG. 2.

The keyboard for inputting multiple languages using a detachable keypad according to the present invention will be described in detail.

The present invention relates to a key board including a base board 50; rows of a plurality of key caps 31 positioned on the base board 50; and a plurality of moving mechanism members 60 connecting the key caps 31 to the base board 50 and enabling the key caps 31 to vertically move with respect to the base board 50. This is the same as described above.

However, major characteristics of the present invention lie in that each of the key caps 31 are divided into an opaque portion 32 and a transparent portion 33, and here, general Korean alphabet and English keypads are permanently marked on the opaque portions and keypads including various languages such as Japanese, Chinese, German, and French languages can be replaced through the transparent portions 33.

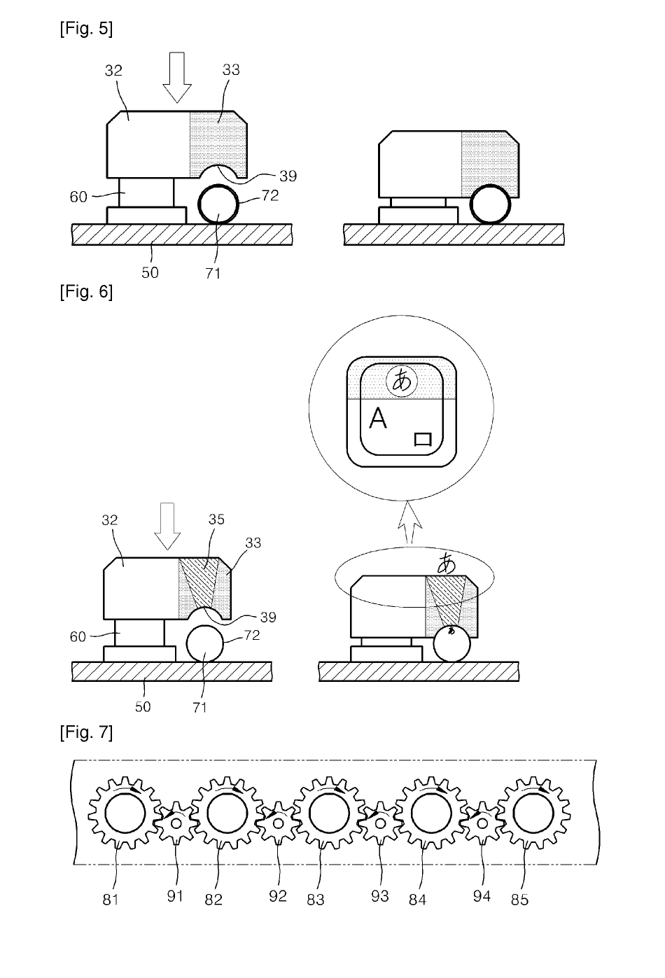

To this end, referring to FIG. 3, the base board 50, the key caps 31, and the moving mechanism members 60 are provided in a case unit 40.

In the present invention, holes 73 are formed on the side of the case unit 40, and an accommodation space is provided in a row direction of the key caps 31 through the holes 73 and a rotatable member 71 with character marks 72 of various languages attached thereto is provided in the accommodation space. The character marks of the rotatable member 71 inserted into the accommodation space may be visible to a user through the transparent portions 33 of the key caps 31.

When displaying languages other than Korean alphabet and English using a computer, the user may rotate the rotatable member 71 on which characters previously set for each of the key caps within the computer to easily recognize the characters corresponding to the key caps, respectively.

In the related art, to this end, a key skin or a sticker is added to upper portions of the key caps, which, however, causes user inconvenience in a replacing operation.

In the present disclosure, the “rows of key caps” refers to a combination of key caps arranged in a horizontal direction in alignment. “One direction of key caps” refers to a direction of key caps in the horizontal direction in alignment.

FIG. 4 illustrates a keyboard according to an embodiment of the present invention. A plurality of rotatable members 71 are provided between the base board 50 and the transparent portion 33 in a row direction of the key caps 31 and having characters marked on an outer surface thereof.

Preferably, the rotatable members 71 have a circular shape, and preferably, characters facing the transparent portion 33 vary depending on a rotation angle. Namely, the plurality of rotatable members 71 provide different characters through the transparent portion 33 according to a rotation angle for users.

In this case, each rotatable member 71 is provided in a circular shape, and a lower portion of the transparent portion 33 has a concave recess 39 corresponding to the rotatable member 71.

As illustrated in FIG. 4, the moving mechanism member 60 is not positioned between the transparent portion 33 and the base board 50. Namely, in the present invention, the moving mechanism member 60 is formed as narrow as possible so as to be positioned to be limited to the opaque portion 32.

The rotatable member 71 is insertedly positioned in a space part below the transparent portion 33. Characters corresponding to key caps 31 through the transparent portions, respectively, need to be marked on the rotatable member 71. The user may recognize characters seen through the transparent portions 33, and may input a desired character by pressing a key cap corresponding to the character. FIG. 5 specifically illustrates an operation of an embodiment of the present invention.

FIG. 6 is a view illustrating a configuration in which a magnifier 35 is inserted into an interior of the transparent portion 33 to enhance user convenience. The transparent portion 33 may include the magnifier 35 to magnify a character in size so as to be visible to the user. The magnifier 35 may have a convex lens shape, or the like.

The rotatable members 71 may be independently rotated, or as illustrated in FIGS. 7 and 8, the rotatable members 71 may be configured to be rotatable on the whole.

Among the plurality of rotatable members 71, neighboring rotatable members are connected through a connection member and may interwork to be rotated by the same rotation angle.

Referring to FIG. 7, serrated gear portions 81, 82, 83, 84, and 85 are provided in each of the rotatable members 71. Also, connection members 91, 92, 93, and 94 respectively engaged with the gear portions to connect the rotatable members 71 are further provided.

Namely, when the user rotates any one rotatable member 71, the other rotatable members are rotated in conjunction therewith by the same angle. Thus, the user may adjust only one rotatable member, without having to adjust all the rotatable members 71 with characters marked thereon one by one.

Also, a rotary motor 99 for adjusting a rotation angle is connected to any one of the plurality of rotatable members 71.

As illustrated in FIG. 7, the rotary motor 99 is provided on the edge, and the rotary motor 99 is connected with the gear portion 85 on the outermost rotatable member through the serrated gears. Namely, when the user inputs a foreign language to be used in the current computer system, the rotatable members are automatically rotated to display characters of the foreign language on the transparent portions through a controller (not shown).

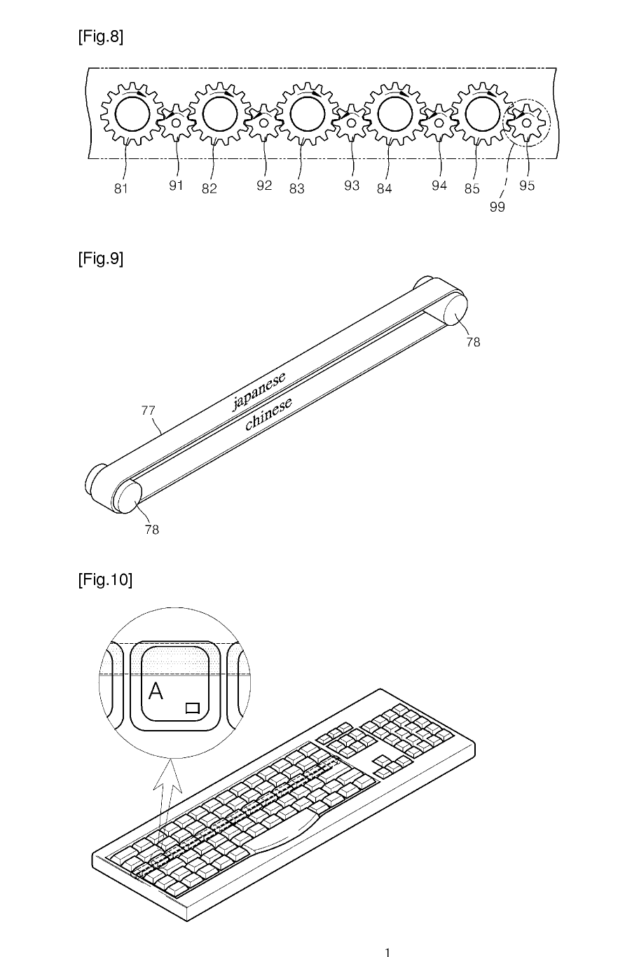

Also, in another embodiment of the present invention, as illustrated in FIG. 9, languages may be easily replaced by using a pair of cylindrical members 78 and a character-inserted belt-type member 77.

As illustrated in FIG. 10, the belt-type member 77 may be horizontally installed in the row of the transparent portions of the key caps of the keyboard, and the cylindrical members 78 are installed to be rotatable on both sides of the keyboard. The belt-type member 77 are rotated according to rotation of the cylindrical members 78, and the user may simply displayed language by positioning the belt-type member 77 of a desired language in the row of the transparent portions of the key caps.

The cylindrical member 78 may be manually rotated or may be rotated by using a small motor.

In this manner, characters of a foreign language set for a computer system in advance are marked on the insertion member, the user may replace the keypad according to a language selected by the computer system, thereby providing user convenience allowing users to easily recognize characters corresponding to key caps.

As the embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

1-4. (canceled)

5. A rotary-type keyboard for inputting multiple languages, the keyboard comprising:
a base board;
rows of a plurality of key caps positioned on the base board; and
a plurality of moving mechanism members connecting the key caps to the base board and enabling the key caps to vertically move with respect to the base board,
wherein the key caps each are divided into an opaque portion and a transparent portion and include a plurality of rotatable members provided between the base board and the transparent portion in a row direction of the key caps and having characters marked on outer surfaces thereof,
wherein the plurality of rotatable members provide different characters through the transparent portions according to rotational angles for a user.

6. The rotary-type keyboard of claim 5, wherein the rotatable members are provided to have a circular shape, and a lower portion of the transparent portion has a concave recess corresponding to the rotatable members.

7. The rotary-type keyboard of claim 5, wherein, neighboring rotatable members, among the plurality of rotatable members, are connected through a connection member and interwork to be rotated by the same rotation angle.

8. The rotary-type keyboard of claim 7, further comprising a rotary motor for adjusting a rotational angle is connected to any one of the plurality of rotatable members.
